(19) United States
(12) Patent Application Publication
(10) Pub. No.: US 2014/0236850 A1
(43) Pub. Date: Aug. 21, 2014

(54) On-Demand, Web-Based Interactive Video Interviewing

(71) Applicant: Jody Neal HOLLAND, Amarillo, TX (US)

(72) Inventor: Jody Neal HOLLAND, Amarillo, TX (US)

(21) Appl. No.: 13/870,802

(22) Filed: Apr. 25, 2013

Related U.S. Application Data
(60) Provisional application No. 61/766,778, filed on Feb. 20, 2013.

(51) Int. Cl. G06Q 10/10

(52) U.S. Cl. CPC G06Q 10/1053
USPC 705/321

(57) ABSTRACT

A method and system for an on-demand web-based interactive video interviewing process provides a convenient and flexible way for candidates and employers to perform an interview in a more objective manner. This on-demand web-based interview process comprises the steps of building an interview set by a customer, informing candidates about an upcoming interview, candidates recording responses, collaborators evaluating recorded answers from candidates and asking follow-up questions for specific candidate, with approval of follow-up questions, the designated candidate being promoted to answer follow-up questions for reevaluation and finally generating an interview report. This interview system also includes a specific function of Click2Interview and a practice platform for candidates and collaborators to practice in a real interview process model. The practice platform provides for a method of posting the practice results to public profiles through the use of a hyper-link.

The current application claims a priority to the U.S. Provisional Patent application Ser. No. 61/766,778, filed on Feb. 20, 2013.

### FIELD OF THE INVENTION

The present invention relates generally to a method and system for an interviewing process. More specifically, the present invention is a method and system for an on-demand web-based interactive video interviewing process.

### BACKGROUND OF THE INVENTION

Interviewing is an important and necessary process for both a person who is job hunting to find the job and an employer who is looking for the “right” people to find the people. Additionally, interviewing is critical for resolving Human Resources issues with present employees. Regarding the people who are looking for a job, in order to get the job, he or she has to go through the interviewing process to allow the employer to accurately evaluate his or her experience and ability. Regarding the employer, it needs to set up, conduct and review the interview by many relevant current employees from various administrative levels to make it certain to hire the “right” people. In resolving HR issues, it is critical to capture accurate information from existing employees and have the appropriate individuals review that submitted information.

Nevertheless, the whole process of traditional interview is actually a big challenge to both sides. Concerning the candidate who is currently searching a position, he or she needs to reschedule his or her time to go to the site for the interview, as well as to prepare and practice the interview with the purpose of making the accurate and best impression to the potential employer. In addition, he or she may need to go to the interview sites for more than once, because different interviewers have their various personal schedules; and the interview cannot be conducted within a single period of time. This prolonged period could bring certain inconvenience. In another scenario, the candidate may still be employed by another employer and therefore need to go to work as normal. In such a case, they may not be able to go to the interview unless the interview time is quite flexible or fits well with their working schedule. Similar scheduling challenges can present themselves when trying to interview existing employees to resolve HR issues.

On the other hand, an employer may find it very difficult to arrange the interviews for a candidate with all of the necessary evaluators and collaborators, as those inside interviewers from various levels and departments often have very different working schedules. Nevertheless, the final hiring decision is usually a collaborative decision that needs the inputs from many people at various levels, such as company executives, managers, supervisors and the people who are going to work together with the future employee. Hence many of them from different levels have to attend the same interview. In light of the foregoing issues, it could be very challenging to get all of the necessary people in the room at the interview time to conduct an interview with a candidate. It may end up with only some of the necessary people showing up at the interview, some people show up late and other necessary people may have to miss the interview completely. This is pretty usually as nowadays, the company executives, leaders, managers and supervisors are asked to accomplish more with less on a regular basis. Because of these hurdles, it could be very challenging to get all the necessary people to attend the interview, which may unfortunately compromise the quality of the final hiring decision.

Additionally, there could be other challenges associated with such traditional live interviews. For example, sometimes its objectivity is very hard to control. It is a human's natural tendency to try to hire the person that is like him or her; but this may not be the best choice in many cases. People are naturally attracted to people who dress, think, or behave in the same manner that they do. In a live interview, many candidates may have been trained to read the interviewer's body language and then respond accordingly. During a live interview, according to SHRM (Society of Human Resource Management), more than two-thirds of hiring decisions are made in the first 4.3 minutes of the interview when the questions relevant to that specific position are yet brought up. In order to remain objective, it is important for the interviewers to focus on listening and reading the candidate, as well as not giving away too much information about what kind of people they want to hire, as the candidates may try to pretend to possess the desired characteristics, even though they actually may not. The interviewers need to focus on how they ask questions and attain useful information from the candidate's responses. They themselves should do very little speaking. The ratio should be at least 80% listening according to some studies.

Finally, there could be another issue that makes the issue of getting “the best person” from an interview become more challenging. Regarding “finding the best”, it has been said repeatedly by human resource experts that the best employees are already employed. Basically, what it means is that the best people are already working for your competitors. Top performers will always be in demand. In order to get those people to come to work for your company, the employer needs to make, at the very beginning, the interview time as convenient and flexible as possible, in order to afford those working people the opportunity to attend the interview.

Therefore, it is a primary object of the present invention to introduce a method and system for an on-demand web-based interactive video interviewing process wherein a company is able to coordinate the logistics of job interviews and automate the collaborative interview schedule and process.

### BRIEF DESCRIPTION OF THE DRAWINGS

FIG. 1 is a diagram showing the general interview process being executed under the processor(s)-executable instructions stored in a non-transitory computer-readable medium.

FIG. 2 is a diagram showing the account administrator-related interview process being executed under the processor(s)-executable instructions stored in a non-transitory computer-readable medium.

FIG. 3 is a diagram showing collaborator-related interview process being executed under the processor(s)-executable instructions stored in a non-transitory computer-readable medium.

FIG. 4 is a diagram showing candidate-related interview process being executed under the processor(s)-executable instructions stored in a non-transitory computer-readable medium.

FIG. 5 is a diagram showing the Click2Interview-related interview process being executed under the processor(s)-executable instructions stored in a non-transitory computer-readable medium.

### DETAIL DESCRIPTIONS OF THE INVENTION

All illustrations of the drawings are for the purpose of describing selected versions of the present invention and are not intended to limit the scope of the present invention.

The present invention is a method and system for an on-demand web-based interactive video interviewing process. In addition, the entire on-demand web-based video interview processes are running through and under the instructions of a non-transitory computer-readable medium that stores instructions executable by one or more processors to perform the method for doing the on-demand web-based interactive video interview. The present invention utilizes the website CloudInterview.com which is a collaborative on-demand interviewing process designed to coordinate the logistics of job interviews and automate the collaborative interview process.

This on-demand web-based interactive video interview system was developed out of a response to executive requests and frustration with a lack of time and collaboration for the interviews that are important for the company's business and development. When an organization is seeking to hire the best possible people, they need to have the input from the people at various top and other related levels in order to make the most informed decision. The on-demand web-based interview system in the present invention helps to increase the flexibility and objectivity, as well as reduce the cost and loss of peak working time, of an interview. It also serves as a platform for the development of interviewing skills of job seekers. Through a well coordinated internet platform, this web-based interview system creates the ability for an interview being conducted on its customer's own time and at any time. It also brings much objectivity to the interviewing process by giving each collaborator (evaluator) an equal voice, effectively eliminating “Group Think” and ensuring that the interview does not sidetrack the interviewer, keeping the interview on-track. It also stabilizes the appropriate ratio of the interviewer performing approximately 20% of the talking and the interviewee performing approximately 80% of the talking.

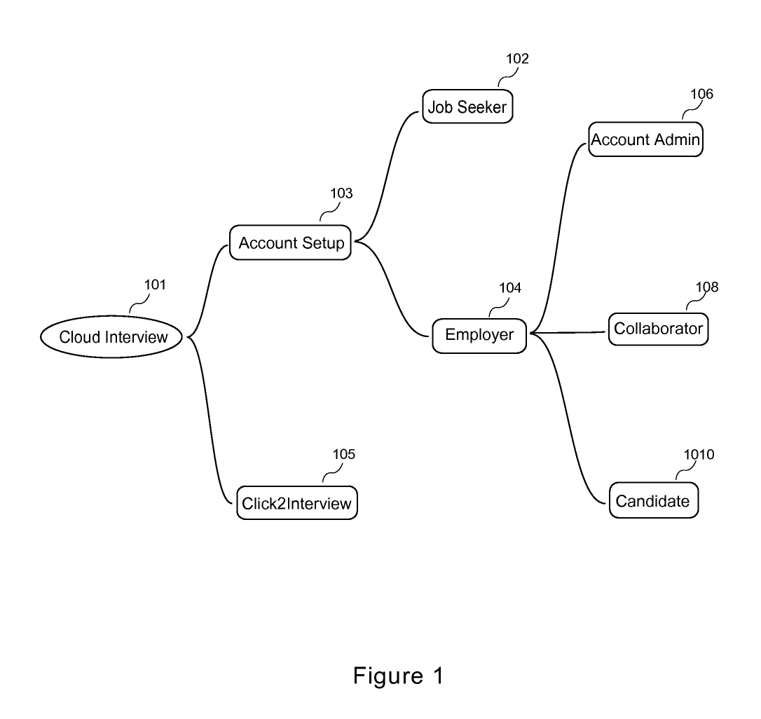

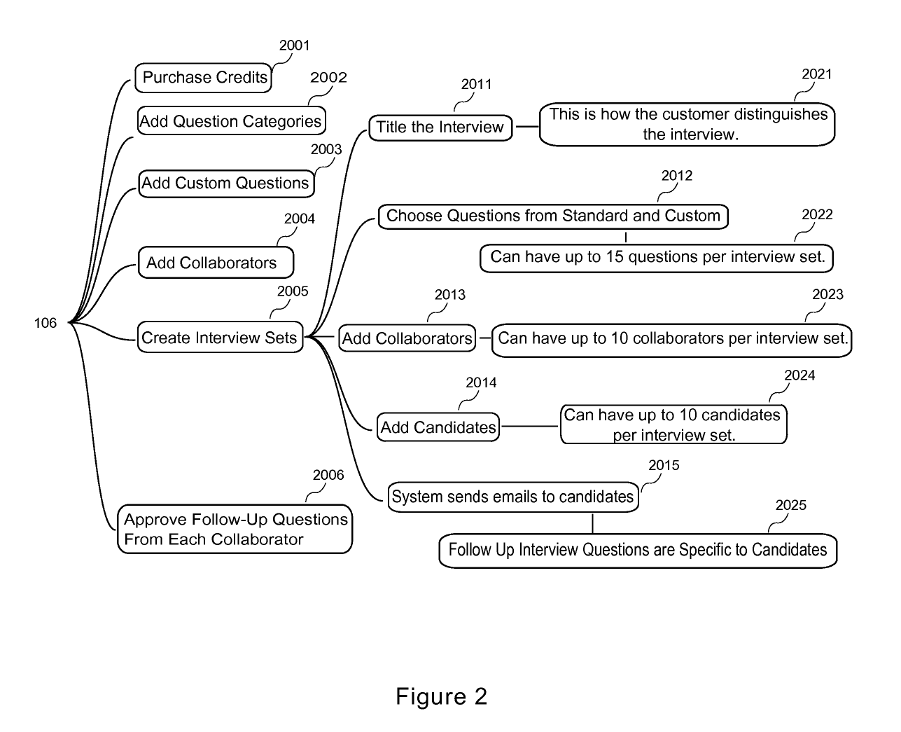

In reference of FIG. 1 and FIG. 2, through the web-based interview process and system, an employing company can set up an employing company account 103 and purchase credit 2001 on the website. Next the company administrators 106 can create custom categories of questions 2002, add custom interview questions 2003 under each of those categories, or use the interview questions that are in the database as “standard” questions 2012. The administrator 106 can also add interview information sets and title the interview 2011. In this way, the customers can distinguish individual interview or interview information sets 2021. For each interview information set, it can have up to 15 questions 2022, including both standard questions and custom questions. To set up a complete interview information set, the customer has the ability to add “collaborators” into the process 108. For each interview information set, there can be up to 10 collaborators 2023. These are the individuals that can review the candidate interviews after the candidate has completed their on-demand video interview. Additionally, an “interview wizard” is provided that allows the company to name the interview (title), add a specific question set of up to 15 questions 2022, choose which people can serve as collaborators for that particular interview 2013; and then add candidates into the interview 2014. It can have up to 10 candidates 2024 for each interview information set. In this way, an interview information set is built 2005. All this information will be saved with the system.

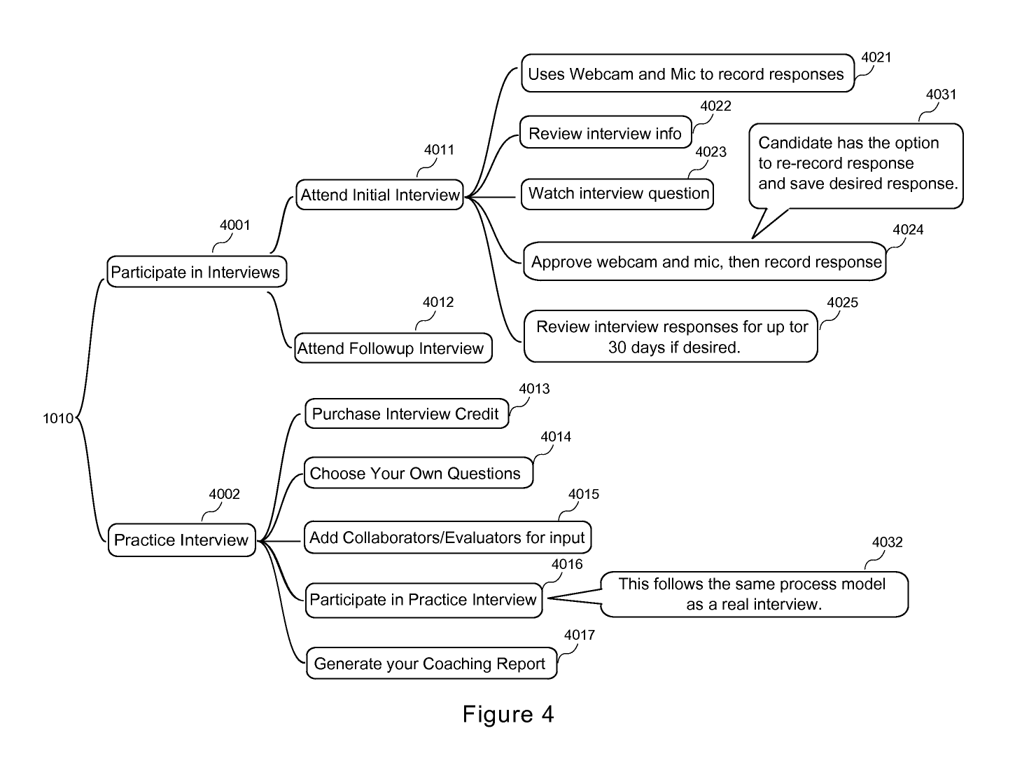

In reference to FIG. 1, FIG. 2 and FIG. 4, the web-based interview system will automatically notify the candidates via email with their interviewing instructions and login information 2015. Each candidate can log into the system and click “attend interview” in order to participate in interviews 4001. What's more important, the candidate 1010 can do this at any time that is convenient and at any internet capable location that they prefer and that has the appropriate computer capabilities. In this initial interview 4011, they will be taken to a new screen upon clicking “attend interview” and can review the interview information 4022, and see the first question as a video, as text, or as both 4023, depending on how the company set it up. They can click on the question to review. They can then click on a window to the right of the question which can request access to their webcam and microphone. They can choose the webcam and microphone and can have the option of testing the microphone for sound recognition as well as seeing themselves on screen from the camera 4024. When they click record, the system can record a streaming video of their answer into the database for review by the collaborators and customer administrators 4024. When they are done recording their answer, they click on “stop” and then on “continue” to go to the next question. The final question can have the button labeled “submit” instead of continue; and this will finalize their interview. Moreover, candidates 1010 have the option to re-record their responses and then save the desired one. They can review interview responses for up to 30 days if desired 4025.

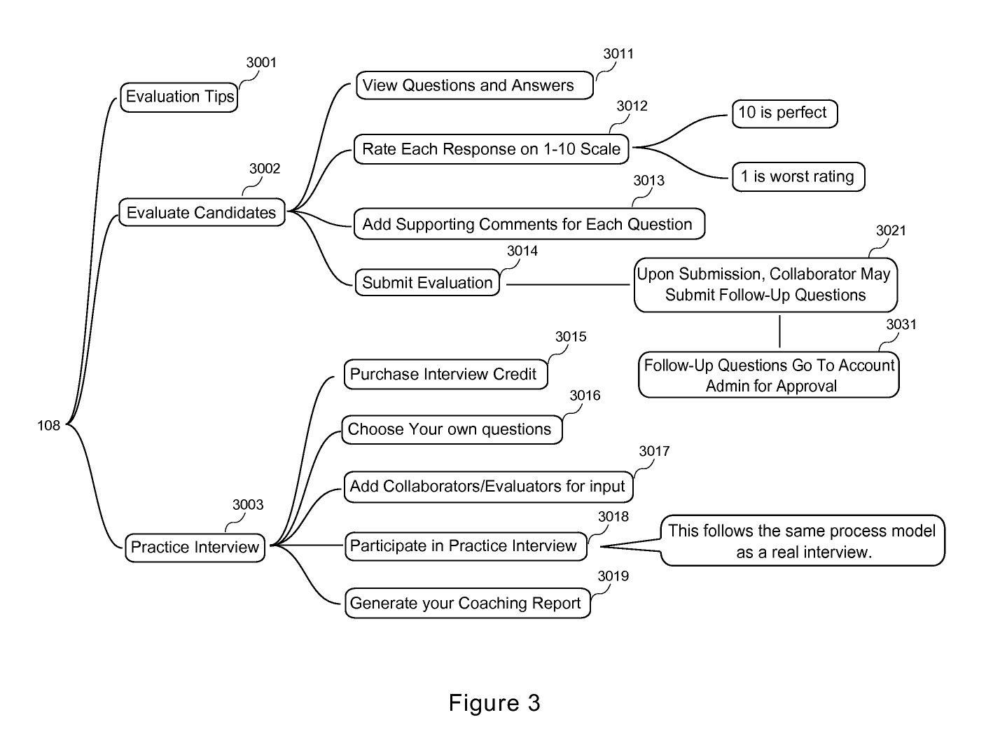

In reference to FIG. 1, FIG. 2 and FIG. 3, upon completion of the candidate interview, an email can be auto-generated from Cloud Interview 101 to each of the assigned collaborators 108, who can be prompted in the email to evaluate the candidate 1010. Upon the collaborator logging in, they can be able to click on the link to evaluate the candidate 1010. If they are assigned to evaluate multiple candidates 1010, a link can be available for each of the candidates 1010 which can take the collaborator directly to the evaluation of the candidate's responses.

The collaborator 108 will view the questions and candidate's answers 3011. The collaborator 108 is provided a page with four areas, namely the interview question, the response by the candidate, the rating system of 1 to 10 with 10 being best and 1 being worst, and a section for free text comments related to the response. The collaborator 108 will have the evaluation tips 3001. Section 1 can contain the interview question. Section 2 can contain the candidate video and/or text response. Section 3 can allow the collaborator to evaluate the candidate 3002 on a scale from 1 to 10 with 10 being the highest rating (perfect) and 1 being the lowest rating 3012. Section 4 can be a comment box where the collaborator may include any supporting comments 3013 related to the response from that particular candidate 1010. Prior to completing their evaluation of the candidate, the collaborators 108 can have a button labeled “Follow-Up Questions” which can allow them to ask follow up questions (up to 2 questions) of that candidate 3021. The questions for follow up are specific to the candidate 2025. Upon completion of their evaluation of the candidate, the collaborator will submit the evaluation 3014. The Cloud Interview system 101 can keep a running average in the interview report, indicated which of the candidates 1010 has obtained the highest average rating on each question as well as overall in the interview. The running average will designate which candidate is the “Top Candidate.” These follow-up questions are recorded and/or typed into the system and submitted to the company administrator for review and approval or disapproval 3031. This step is to make sure that each question a candidate 1010 is asked is a proper one. Upon the approval of each interview question 2006, it is added to a new interview information set with the same interview title, plus the following, “Follow Up for <first name last name>” to specify which candidate 1010 will be asked this specific question. Only approved questions can be added to the interview information set. And the candidates 1010 will be informed by email about the follow-up questions. They will have the ability to record their answers to these follow-up questions 4012. Their answers will be further reviewed again by the collaborator and further review comments could be made based on these new answers. A separate report will be generated showing the follow-up evaluation.

The system can allow the account administrator 106 of the company to close out the interview after at least 1 collaborator has completed their evaluation. Once the interview is closed out, the Cloud Interview system 101 can create a “Top-Candidate” interview report, which rank orders the candidates from best to worst, providing the averages of the collaborator responses, thumbnails of the questions and responses, and comments from each collaborator, related to the candidate responses. Prior to closing out the interview, the company administrator 106 can have the ability to add additional candidates into the interview. They can also have the ability to add additional collaborators 108 into the system prior to closing out the interview. In addition, the system also allows for the addition of a single candidate at a time inside of an employee management system. And a new upgrade of the system now allows removing the limit on how many candidates can be in a single interview information set.

The practice interview platform functions in much the same way as the standard Cloud Interview process. The exception is that the candidate can purchase a “practice interview” credit through the e-commerce portal and then may choose their own interview questions and their own collaborators. Once they hit save, they will be able to attend their practice interview and their collaborators will be notified upon their completion via email and will be able to give advice and evaluation of the interview responses.

The on-demand web-based interview system in the present invention has several advantages over the normal live interview process, which help to overcome the aforementioned challenges an interview may face. First, concerning the objectivity of the interview, as the candidates 1010 do not see the interviewer's expression and response to their answers, it makes it impossible for them to guess what kind of people the employer 104 is looking for and then pretend to be that kind of person and behave accordingly. On the other hand, since the interviewer can only see the candidates' answers, the interviewers' final decision should be less influenced by those foregoing not-that relevant issues such as whether the candidates are a similar person like the interviewer; rather mainly based on the candidates' reply to the questions and qualification to the job. It also gives equal voice to each of the collaborators. This specific feature makes the interview more objective. Second, concerning the potential schedule conflict, with using the interview system (Cloud Interview 101), a company is able to create their interview, send it to all of the candidates, and then have each of the key collaborators 108 (evaluators) review the information on their own time. This ensures that the interview gets full participation and consistent feedback, regardless of various individual schedules. In addition, it also enables the candidates to answer the questions on their convenient time, without interfering too much with their current work and life. This will allow the employer 104 to have a bigger candidate pool to choose from; and make it possible for those good candidates who are currently working for competitors or other employers to apply for the position as now they can make the interview without taking off from their current work. In this way, this web-based on-demand interview system levels the playing field for both the employer 104 and the candidates 1010.

The interactive interview process for on-line, on-demand interviews contains the following key components and features:

1. The ability to create custom interviews, specific to a position.

2. The ability to have up to 10 interview collaborators.

3. The ability to have up to 10 or even unlimited number of candidates for an interview information set.

4. The auto-tabulation of the collaborator ratings.

5. Atop candidate and rank ordered reporting system.

6. The ability to ask follow up questions as a collaborator.

7. The ability to create “Click2Interview” sets.

8. The ability to add collaborators and/or candidates after the interviewing has already started.

9. The ability for a collaborator to also be a candidate and vice versa.

10. The ability to participate in practice interviewing as a candidate or as a collaborator.

The disclosed on-demand, web-based interactive video interview system is specifically designed with a few unique characteristics, including the foregoing follow-up and reevaluation process, as well as a convenient Click2Interview 105 function, and the application as a useful practice platform for candidates 1010 and collaborators 108.

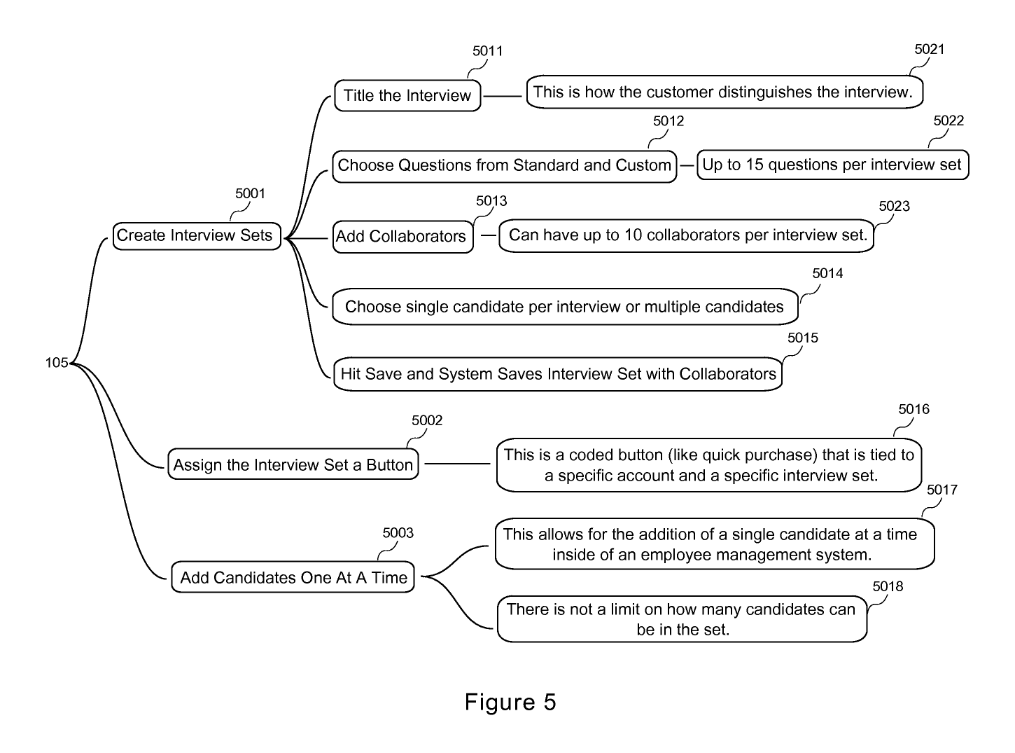

In reference to FIG. 5, the Click2Interview 105 process is a way to go through the interview wizard and save a particular interview information set and collaborator set for quick interviewing through integration of the coded button into an outside program, such as an Applicant Tracking System (ATS). Simply speaking, it is just likes a “Buy Now” button with eBay, which ties a product and description to a company and a price. Click2Interview is similar: With establishing a set of interview questions, the individuals that are to be assigned as collaborators to that interview set. After that, it can be chosen as a running (add multiple candidates) or single (one candidate at a time) interview. You then create the button which ties the interview and collaborators to the company. By clicking the button inside an internal employment management system, the company has only to add the candidate and the interview is scheduled. It can enable organizations to provide a button in their own management system that controls the questions that are asked and who does the evaluation; also allows for the addition of multiple candidates into the interview information set by the administrator 106. Companies can create“Click2Interview” 105 buttons 5002 for any interview combination they would like. These buttons and corresponding embed codes are saved in the “Click2Interview” 105 section with a title for each and description for each. This is how the customer distinguishes the interview 5021. The interview information set(s) will be established 5001. With the establishment of a set of interview questions (standard and custom) 5012 and the individuals that are to be assigned as collaborators 5013 to that interview information set, the candidate(s) will be chosen next and determined as being a running (add multiple candidates) or single (one candidate at a time) interview 5014. There are up to 15 questions per interview information set 5022; and up to 10 collaborators per interview information set 5023. Next, by hitting Save, the system will save the interview information set with collaborators 5015. Then a specific button will be created 5002, which is a coded button (like quick purchase), which ties the interview information set including the collaborators to a specific account of the customer company 5016. With adding candidates one at a time 5003, it allows for the addition of a single candidate at a time inside of an employee management system 5017. There is no limit on how many candidates can be in the set 5018. By clicking the button inside an employee management system, the customer company has only to add the candidate and the interview is scheduled.

The system can store the evaluations of each interview until they are deleted by the company. The video component of the interview responses may be downloaded as an .flv file by the company and by the candidate for up to 30 days after the interview. After 30 days, the video thumbnail can be saved, but not the video itself. This creates a flexibility of application of the system, which makes it useful for many different types of interviewing, including HR investigations, news media usage, membership testimonials, and more.

Furthermore, in reference to FIG. 1, FIG. 3 and FIG. 4, this interview system also comprises a practice function 4002. This platform enables candidates 1010 (as well as collaborators 108) to purchase credits 4013 to practice interviews for the purposes such as personal developments 4016. This platform runs as an integrated component of the Cloud Interview system 101 in the present invention. It enables a person to buy practice credits 4013 and then to choose from a list of standard, pre-recorded interviews questions with tags for industry, level of position, and by person interviewing 4014. These interviews can be pre-recorded by influential people. The person participating in the practice interview can have the ability to add “independent” evaluators known as collaborators (up to 5) for review of their interview 4015. The evaluators can work just like collaborators 108, only without the ability to ask follow up questions. The evaluators can provide feedback for the practice interviewer in order to improve their skills in interviewing. There are four levels of accounts in the system. There are company administrators 106, who have access to all company information. They can see candidates, collaborators, and sub-admins or location managers. They can also create of these. The sub-admins or location managers have the ability to manage, create, and implement interviews the same as the company administrator 106, but only for their location. They also have access only to the amount of interview credits that the company administrator 106 as allocated to them. The collaborator is the individual who evaluates candidates after the interview process. They can see and evaluate the candidates that are assigned to them. They can also participate in the practice interviewing platform 3003. Candidates can see their account, any interviews that they have participated in, and can participate in the practice interviewing platform. A candidate can see all interviews that they have participated in, regardless of the company. They can also have the ability to download their responses if they would like, for up to 30 days from the date of the interview. Moreover, the candidates can decide whether to post their favorite interview practice set to the internet. If they decide to do so, a provided hyperlink can facilitate such action. A candidate can post his practice interview to the internet through the hyperlink. Additionally, he can also share his practice interview on a social profile or send such interview practice to a potential employer.

The practice follows the same process model as a real interview 4032. The practice interview platform of CloudInterview.com allows any candidate or evaluator/collaborator to construct their own interview information set from the list of available questions in the interview database. It allows them to choose up to 5 people to evaluate their interview after they have completed the interview online. It allows those evaluators/collaborators to give input and suggestions as to what the interviewee can do to more effectively interview in the future. This is delivered in the form of a coaching report back to the practice interviewee 4017. Additionally, a candidate can interview with multiple companies with a single account. The interview credits are the usage of an interview and are reduced with the assignment of the interview at a rate of 1 credit per candidate. A practice interview credit is priced separately from a standard interview credit. It allows for a smaller number of participants as collaborators/evaluators. Moreover, the collaborators 108 can attend the interview practice as a job seeker 102, just like the candidates 3003.

The designed web-based interviewing process and system disclosed in the present invention makes an interview more convenient and flexible, reduces the costs compared with a live interview, brings in the interviewers who have a busy or conflicting schedule and brings in the candidates who may also have a busy schedule or are currently working for another employer. It makes the process of finding the right people easier and more efficient.

Although the invention has been explained in relation to its preferred embodiments, it is to be easily understood that many other possible modifications and variations can be made without departing from the spirit and scope of the invention as herein described.

What is claimed is:

1. A non-transitory computer-readable medium that stores instructions executable by one or more than one processors to perform a method for performing an on-demand web-based interview, comprising
instructions for opening an employing company account by an employing company;
instructions for opening candidate accounts by candidates;
instructions for creating an interview information set;
instructions for adding interview questions to said interview information set;
instructions for adding collaborator names to said interview information set;
instructions for adding candidate names to said interview information set; and
instructions for adding a title to said interview information set.

2. The non-transitory computer-readable medium that stores instructions executable by one or more than one processors to perform the method for performing the on-demand web-based interview of claim 1, comprising
instructions for scheduling said interview; and
instructions for notifying said candidates about said interview.

3. The non-transitory computer-readable medium that stores instructions executable by one or more than one processors to perform the method for performing the on-demand web-based interview of claim 2, comprising
instructions for logging into said candidate accounts by said candidates;
instructions for testing recording devices, wherein said recording devices comprise a webcam and a microphone;
instructions for recording answers to said interview questions;
instructions for determining to respond with said recorded answers; and
instructions for submitting said recorded answers when the determination is to respond with said recorded answers.

4. The non-transitory computer-readable medium that stores instructions executable by one or more than one processors to perform the method for performing the on-demand web-based interview of claim 3, comprising
instructions for notifying collaborators about said submitted answers.

5. The non-transitory computer-readable medium that stores instructions executable by one or more than one processors to perform the method for performing the on-demand web-based interview of claim 4, comprising
instructions for evaluating and rating said candidates based on said submitted answers; and
instructions for adding supporting comments.

6. The non-transitory computer-readable medium that stores instructions executable by one or more than one processors to perform the method for performing the on-demand web-based interview of claim 5, comprising
instructions for calculating average ratings of said candidates;
instructions for creating a candidate ranking list; and
instructions for providing thumbnail icons for said interview questions, said submitted answers and said collaborator supporting comments.

7. The non-transitory computer-readable medium that stores instructions executable by one or more than one processors to perform the method for performing the on-demand web-based interview of claim 6, comprising
instructions for submitting follow-up questions to a company administration for approval, wherein said follow-up questions are for respective candidates;
instructions for approving said follow-up questions; and
instructions for sending said approved follow-up questions to said respective candidates.

8. The non-transitory computer-readable medium that stores instructions executable by one or more than one processors to perform the method for performing the on-demand web-based interview of claim 7, comprising
instructions for recording answers to said approved follow-up questions by said respective candidates; and
instructions for submitting said answers to said approved follow-up questions.

9. The non-transitory computer-readable medium that stores instructions executable by one or more than one processors to perform the method for performing the on-demand web-based interview of claim 8, comprising
instructions for evaluating said answers to said approved follow-up questions; and
instructions for generating an interview report.

10. The non-transitory computer-readable medium that stores instructions executable by one or more than one processors to perform the method for performing the on-demand web-based interview of claim 9, comprising
instructions for adding additional candidates to conduct said interview, prior to interview closure; and
instructions for adding additional collaborators to perform evaluation and rating, prior to said interview closure.

11. The non-transitory computer-readable medium that stores instructions executable by one or more than one processors to perform the method for performing the on-demand web-based interview of claim 1, comprising instructions for performing a function of Click2Interview, and said function of Click2Interview comprising instructions for creating a coded button in an internal employment management system of said employing company;
instructions for assigning said coded button to said interview information set;
instructions for linking said interview information set to said internal employment management system through said coded button; and
instructions for managing said interview information set from said internal employment management system through said coded button.

12. The non-transitory computer-readable medium that stores instructions executable by one or more than one processors to perform the method for performing the on-demand web-based interview of claim 1, comprising a function of practice, and said function of practice comprising
instructions for purchasing practice interview credits;
instructions for selecting practice interview questions;
instructions for adding evaluators to provide evaluative inputs;
instructions for performing a practice interview;
instructions for evaluating said practice interview;
instructions for generating a coaching report;
instructions for determining to submit said practice interview to a website;
instructions for posting said practice interview to said website through a hyperlink, when the determination is to submit;
instructions for sharing said posted practice interview on a social profile; and
instructions for sending said posted practice interview to a potential employer.

13. A non-transitory computer-readable medium that stores instructions executable by one or more than one processors to perform a method for performing an on-demand web-based interview, comprising
instructions for opening an employing company account by an employing company;
instructions for opening candidate accounts by candidates;
instructions for creating an interview information set;
instructions for adding interview questions to said interview information set;
instructions for adding collaborator names to said interview information set;
instructions for adding candidate names to said interview information set;
instructions for adding a title to said interview information set;
instructions for creating a coded button in an internal employment management system of said employing company;
instructions for assigning said coded button to said interview information set;
instructions for linking said interview information set to said internal employment management system through said coded button; and
instructions for managing said interview information set from said internal employment management system through said coded button.

14. The non-transitory computer-readable medium that stores instructions executable by one or more than one processors to perform the method for performing the on-demand web-based interview of claim 13, comprising
instructions for scheduling said interview;
instructions for notifying said candidates about said interview;
instructions for logging into said candidate accounts by said candidates;
instructions for testing recording devices, wherein said recording devices comprise a webcam and a microphone;
instructions for recording answers to said interview questions;
instructions for determining to respond with said recorded answers; and
instructions for submitting said recorded answers when the determination is to respond with said recorded answers.

15. The non-transitory computer-readable medium that stores instructions executable by one or more than one processors to perform the method for performing the on-demand web-based interview of claim 14, comprising
instructions for notifying collaborators about said submitted answers;
instructions for evaluating and rating said candidates based on said submitted answers; and
instructions for adding supporting comments.

16. The non-transitory computer-readable medium that stores instructions executable by one or more than one processors to perform the method for performing the on-demand web-based interview of claim 15, comprising
instructions for calculating average ratings of said candidates;
instructions for creating a candidate ranking list; and
instructions for providing thumbnail icons for said interview questions, said submitted answers and said collaborator supporting comments.

17. The non-transitory computer-readable medium that stores instructions executable by one or more than one processors to perform the method for performing the on-demand web-based interview of claim 16, comprising
instructions for submitting follow-up questions to a company administration for approval, wherein said follow-up questions are for respective candidates;
instructions for approving said follow-up questions; and
instructions for sending said approved follow-up questions to said respective candidates.

18. The non-transitory computer-readable medium that stores instructions executable by one or more than one processors to perform the method for performing the on-demand web-based interview of claim 17, comprising
instructions for recording answers to said approved follow-up questions by said respective candidates;
instructions for submitting said answers to said approved follow-up questions;
instructions for evaluating said answers to said approved follow-up questions; and
instructions for generating an interview report.

19. The non-transitory computer-readable medium that stores instructions executable by one or more than one processors to perform the method for performing the on-demand web-based interview of claim 18, comprising
instructions for adding additional candidates to conduct said interview, prior to interview closure; and
instructions for adding additional collaborators to perform evaluation and rating, prior to said interview closure.

20. The non-transitory computer-readable medium that stores instructions executable by one or more than one processors to perform the method for performing the on-demand web-based interview of claim 13, comprising a function of practice, and said function of practice comprising
instructions for purchasing practice interview credits;
instructions for selecting practice interview questions;
instructions for adding evaluators to provide evaluative inputs;
instructions for performing a practice interview;
instructions for evaluating said practice interview;
instructions for generating a coaching report;
instructions for determining to submit said practice interview to a website;
instructions for posting said practice interview to said website through a hyperlink when the determination is to submit;
instructions for sharing said posted practice interview on a social profile; and
instructions for sending said posted practice interview to a potential employer.
